(19) United States
(12) Patent Application Publication
(10) Pub. No.: US 2015/0136802 A1
(43) Pub. Date: May 21, 2015

(54) LIQUID DISPENSING SYSTEM

(71) Applicant: PILKINGTON GROUP LIMITED, LATHOM (GB)

(72) Inventor: Matthew A. Rapin, Tecumseh, MI (US)

(21) Appl. No.: 13/261,942

(22) PCT Filed: Mar. 19, 2013
(86) PCT No.: PCT/GB2013/050691

§ 371 Date: Aug. 19, 2014

Related U.S. Application Data
(60) Provisional application No. 61/613,547, filed on Mar. 21, 2012.

(51) Int. Cl. B05B 11/00; B05B 11/06

(52) U.S. Cl. CPC B05B 11/0021; B05B 11/06
USPC 222/1; 222/394; 222/189.11

(57) ABSTRACT

A liquid dispensing system includes a container for holding a quantity of liquid material, the container having an access opening and a connector structure to operably connect a fluid inlet/discharge structure to the container. Optionally, the liquid dispensing system may include a gaseous fluid treatment component. A method of operating the liquid dispensing system is an aspect of the invention.

### BACKGROUND OF THE INVENTION

The invention is related to a liquid dispensing system. More particularly, the invention relates to a system for dispensing a liquid material directly from the container in which it was supplied by the manufacturer of such liquid material, the system optionally incorporating a gaseous fluid treatment component.

Liquid dispensing systems incorporating at least one gaseous stream treatment component are known in the patent literature, for example:

U.S. Pat. No. 4,689,057 describes a drum dehumidifying breather for a liquid chemical container including a desiccant canister having a top wall, a cylindrical transparent side wall, and a removable bottom wall; the canister containing a desiccant material; the cylindrical side wall having a threaded portion which extends below the bottom wall; the bottom wall being capable of supporting the desiccant material and containing breather holes for the passage of dried air from the canister; an annular removable cap having a threaded side wall which is capable of being attached and connected to the threaded portion of the side wall of the canister; a supporting cylinder positioned in the annular opening of the cap; one end of the supporting cylinder being in communication with the bottom wall of the canister and capable of supporting the bottom wall as well as containing breather holes to allow passage of dried air through said supporting cylinder and into the liquid chemical container; and the opposite end of the supporting cylinder capable of being threaded for attachment to the liquid chemical container.

U.S. Pat. No. 6,217,639 describes a contamination control breather wherein air enters the contamination control breather through openings in the top cap of the breather. Air then passes through air channels in the top cap. Dust particles are filtered by a filter assembly near the top of the breather, which also diffuses the air. The diffused air then passes through material which removes moisture, other gases, and liquids from the air. The air is then passed through another filtration layer to remove the desiccant particles from the air. The clean and dry air ultimately passes to a container or machinery that uses filtered air, through an aperture in the bottom cap of the breather. The bottom cap can be permanently attached to the container so that only the elongated body and the filter assemblies need to be replaced when the desiccant reaches the maximum adsorption capacity.

U.S. Pat. No. 4,146,277 describes a cap designed to provide a prolonged dehumidification of the contents of an associated container, an indication of the condition of the desiccant without exposing the contents, a rapid regeneration of the desiccant and a permanent isolation of the desiccant, by means of an inert high isolation fiber, self-forming hermetic seals, and a high thermal conductivity case.

U.S. Pat. No. 6,274,209 describes a venting cap having a cavity, at least one first passage for fluids connecting the cavity with the inside of the container, at least one second passage for fluids connecting the cavity with the outside of the container, and a liquid-absorbing mass arranged within the cavity. The liquid-absorbing mass is said to act, after absorption of liquid, as a selective filter prohibiting the passage of liquid, but permits the passage of gas. This arrangement is said to ensure the foolproof selective permeation of gas but not of liquid.

### SUMMARY OF THE INVENTION

The invention relates to a liquid dispensing system. More particularly, the invention relates to a system for dispensing a liquid material directly from the container in which it was supplied by the manufacturer of such liquid material, the system optionally incorporating a gaseous fluid treatment component.

In one embodiment, the liquid dispensing system of the invention includes a container capable of holding a quantity of a liquid material, the container having an access opening, typically, with a male connector structure extending therefrom, and a fluid inlet/discharge structure including a base portion, and disposed in and through the base portion, a gaseous fluid inlet port and a liquid discharge port, and typically, extending substantially perpendicularly from the base portion, a female access opening connector flange for connecting to the male connector structure of the container.

Optionally, the liquid dispensing system of the invention includes, as a component thereof, at least one gaseous fluid treatment device, for example, a device for removing undesired water vapor from the gaseous fluid stream entering the liquid material container through the gaseous fluid inlet port. Removal of such undesired water vapor or other contaminants is considered “treatment” of the gaseous fluid stream for purposes of this application.

A method of dispensing liquid from a container utilizing the liquid dispensing system defined and claimed herein is also a part of the invention.

According to an aspect of the present invention there is provided a liquid dispensing system comprising a container capable of holding a quantity of a liquid material, the container having an access opening with a male connector structure extending therefrom; and a fluid inlet/discharge structure comprising:

a base portion;

a gaseous fluid inlet port formed in the base portion

a liquid discharge port formed in the base portion; and

a female access opening connector flange extending from the base portion for connection to the male connector structure of the container.

Preferably the system further comprises at least one gaseous fluid treatment device in a gaseous fluid inlet line which enters the gaseous fluid inlet port.

Preferably the at least one gaseous fluid treatment device primarily removes undesired water vapor from the gaseous fluid.

Preferably a gaseous fluid inlet line conveys treated gaseous fluid through the gaseous fluid inlet port into the container and a liquid discharge line conveys liquid from the container through the liquid discharge port.

Preferably the discharged liquid is conveyed through the liquid discharge line to a liquid applicator device.

According to an aspect of the present invention there is provided a fluid inlet/discharge structure adapted to be connected to an opening of a container comprising:

a base portion having inner and outer major surfaces;

at least one reinforcing member attached to the base member;

a gaseous fluid inlet opening extending through the base portion and the at least one reinforcing member;

a liquid discharge opening extending through the base portion and the at least one reinforcing member;

a male gaseous fluid inlet structure extending from the outer major surface of the base portion and connected to the gaseous fluid inlet opening, forming a gaseous fluid inlet port;

a male liquid discharge structure extending from the inner and outer major surfaces of the base portion and connected to the liquid discharge opening, forming a liquid discharge port; and

a female access opening connecting flange extending from the base portion capable of connecting to a male access opening connector structure on a liquid material container.

Preferably the female connecting flange has threads formed in an inner surface thereof.

Preferably the female connecting flange has a snap-fit flange formed in an inner surface thereof.

According to an aspect of the present invention there is provided a liquid dispensing system comprising a container capable of holding a quantity of a liquid material having an access opening to which a fluid inlet/discharge structure is operably connected in a liquid-tight manner, the fluid inlet/discharge structure having a base portion further comprising a treated gaseous fluid inlet port and a liquid discharge port.

According to an aspect of the present invention there is provided a method of dispensing liquid from a container comprising:

treating a gaseous fluid to reduce moisture/remove contaminants therefrom;

conveying the treated gaseous fluid through an inlet line to a fluid inlet/discharge structure connected to a container;

injecting the treated gaseous fluid into the container through a gaseous fluid inlet port in the fluid inlet/discharge structure;

discharging liquid from the container through a liquid discharge port in the fluid inlet/discharge structure;

conveying the discharged liquid through a discharge line to a liquid application system; and

applying the liquid to an article.

Preferably the liquid comprises an adhesion-promoting primer.

Preferably the article is a glass vehicle window.

Preferably a conveying force is provided by a pump or like device.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention will now be further described by way of the following specific embodiments, which are given by way of illustration and not of limitation, with reference to the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 shows a perspective view of the liquid dispensing system according to the present invention; and

FIG. 2 shows a plan view of the inner surface of the fluid inlet/discharge structure according to the present invention.

### DETAILED DESCRIPTION OF THE INVENTION

The invention relates to a liquid dispensing system. More particularly, the invention relates to a system for dispensing a liquid material directly from the container in which it was supplied by the manufacturer of such liquid material. The liquid dispensing system optionally, includes a gaseous fluid treatment component.

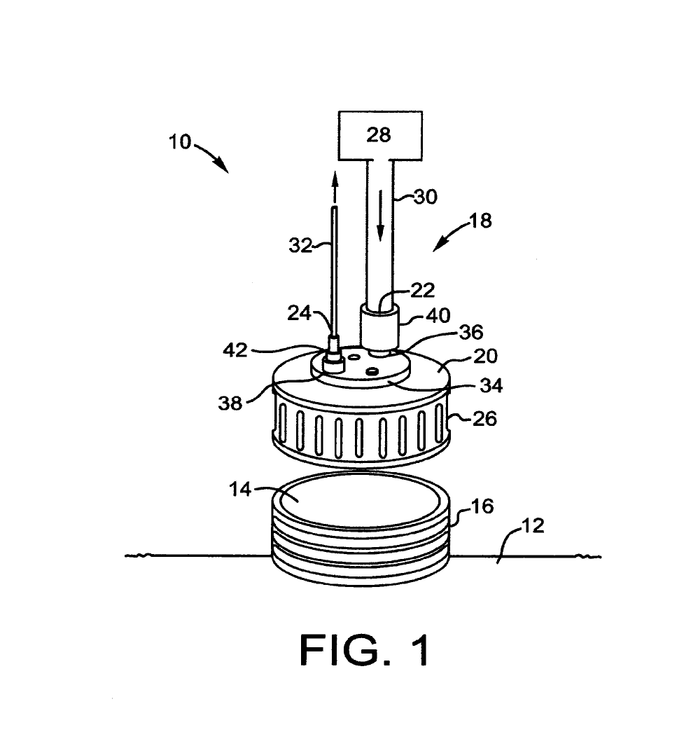

In one embodiment, as best seen in FIG. 1, the liquid dispensing system 10 of the invention includes a container 12 capable of holding a quantity of a liquid material. The container 12 has an access opening 14, typically with a male connector structure 16 extending therefrom. A fluid inlet/discharge structure 18, includes a base portion 20, disposed on and extending through base portion 20, a male gaseous fluid inlet structure 40 and a male liquid discharge structure 42, and extends substantially perpendicularly from the base portion 20 toward male connector structure 16. A female access opening connector flange 26 is provided for connecting fluid inlet/discharge structure 18 to the male connector structure 16 of the container 12.

Optionally, the liquid dispensing system 10 of the invention includes, as a component thereof, at least one gaseous fluid treatment device 28 for removing undesired contaminants, for example water vapor, from the gaseous fluid prior to its traveling through gaseous fluid inlet line 30 to enter male gaseous fluid inlet structure 40 via gaseous fluid inlet port 22. Preferably, the liquid and gaseous materials are drawn through liquid dispensing system 10 by a pump or like device, typically such device being connected to liquid discharge line 32.

Entry of the preferably treated gaseous fluid through male treated gaseous fluid inlet structure 40 into container 12 preferably results in movement of the liquid material contained in container 12 into an interior portion of liquid discharge line 32 disposed in container 12 and subsequent movement through liquid discharge opening 38, male liquid discharge structure 42, liquid discharge port 24 and continuing on through an exterior portion of liquid discharge line 32 outside of container 12, preferably through a pump or like device, then to a chosen liquid application system, for example, an adhesion promoting primer application system. The liquid primer application system is not a part of the invention.

Again referring to FIG. 1, the components of liquid dispensing system 10 will now be described in more detail. In this preferred configuration, liquid dispensing system 10 includes a base portion 20 of any suitable geometric shape, but preferably a circular shape, and made from any suitable material, but preferably made from a polymeric material. The system further includes a female access opening connector flange 26 extending substantially perpendicularly from base portion 20 toward male connector structure 16. The base portion 20 and female access opening connector flange 26, when suitably connected, may form a lid or cap. While not shown in the drawings, the female access opening connector flange 26 is preferably threaded in its interior portion so as to be capable of a screw-on connection with male connector structure 16 which is, likewise, preferably threaded, although other connection means, such as a snap-on connection, are possible. The female access opening connector flange 26 may be any suitable shape, but is preferably cylindrical if base portion 20 is circular. Preferably, female access opening connector flange 26 is made from a polymeric material, more preferably from the same polymeric material from which base portion 20 is formed.

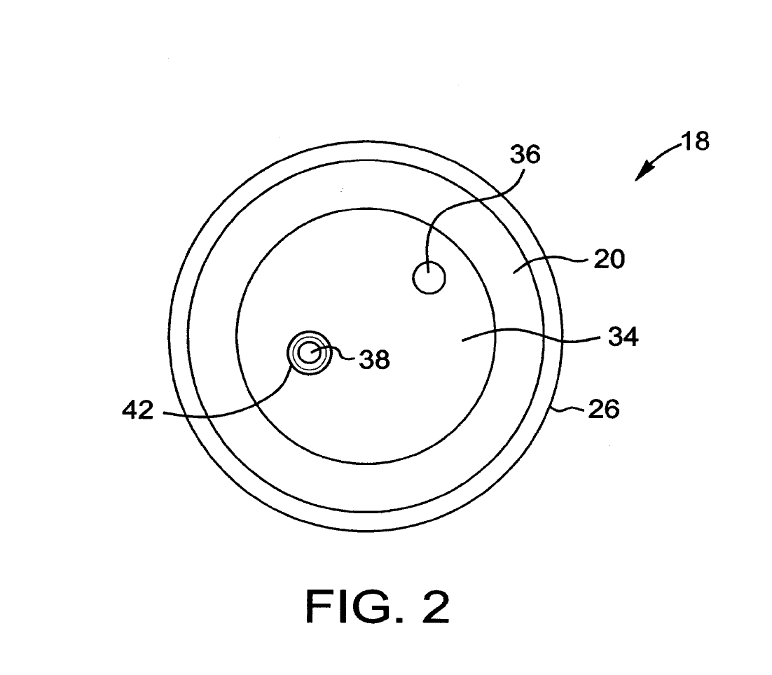

The liquid dispensing system may further include an optional reinforcing member 34, preferably having inner and outer portions as shown in FIGS. 1 and 2, which portions are attached to one another, by any suitable means, through base portion 20, for example, by screws, rivets, pins or the like. Optional reinforcing member 34 may have any suitable size and shape, but is preferably similar in shape to base portion 20, and is preferably somewhat smaller in size than base portion 20. Optional reinforcing member 34 may be made from any suitable material, but is preferably made from a high strength material relative to the preferred polymeric material of base portion 20, for example, a metal material, such as aluminum or steel.

As best seen in FIG. 2, gaseous fluid inlet opening 36 and liquid discharge opening 38 are formed in predetermined, spaced apart locations through base portion 20, preferably though optional reinforcing member 34. The two openings 36, 38 may be the same or different sizes, whichever size relationship allows the system of the invention to most readily and uniformly dispense the liquid contained in container 12.

Outside of container 12, male gaseous fluid inlet structure 40, having a complementary shape to gaseous fluid inlet 36, is installed in gaseous fluid inlet 36 by any suitable means so as to form a substantially gaseous fluid-tight connection therebetween. Gaseous fluid inlet structure 40 may be of any suitable shape or size, but in its most basic form comprises a cylinder, and may have a “cylinder-within-a-cylinder” configuration, the outer end of which preferably is gaseous fluid inlet port 22. Gaseous fluid inlet structure 40 may be formed from any suitable material, for example, brass, aluminum and steel. Preferably, gaseous fluid inlet port 22 is of an appropriate size to receive gaseous fluid inlet line 30, which optionally may connect to gaseous fluid treatment device 28. Overall, male gaseous fluid inlet structure 40 provides the primary path of entry of preferably treated gaseous fluid into container 12.

Similarly to male gaseous fluid inlet structure 40, on the liquid discharge side of the system, male liquid discharge structure 42 is installed by any suitable means into liquid discharge opening 38. Male liquid discharge structure 42 may have any suitable size and shape, but preferably has a shape and size complementary to the shape and size of liquid discharge opening 38. While not restricted thereto, male liquid discharge structure 42 may be cylindrical in shape and may also have a “cylinder-within-a-cylinder” configuration, with the distal end thereof comprising liquid discharge port 24. As previously described herein, liquid discharge line 32 is preferably received in liquid discharge port 24. Male liquid discharge structure 42 may be formed from any suitable material, for example, brass, aluminum and steel. Overall, the male liquid discharge structure 42 provides the primary path of discharge of liquid material from container 12, as drawn therethrough by, for example, a lobe-type pump connected to liquid discharge line 32.

The liquid dispensing system 10 of the invention preferably is capable of discharging between 0.5 ml/min. and 5 ml/min. of liquid material for use in, for example, adhesive bonding or adhesion-promoting priming apparatus.

In a preferred application of the invention, the liquid to be dispensed is an adhesion-promoting primer material as is known to those skilled in the art. The article upon which the material from the the liquid dispensing system is disposed is preferably a glass vehicle window.

In accordance with the provisions of the patent statutes, the present invention has been described in what is considered to represent its preferred embodiments. However, it should be noted that the invention can be practiced otherwise than as specifically illustrated and described without departing from its spirit or scope.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1-13. (canceled)

14. A liquid dispensing system comprising a container capable of holding a quantity of a liquid material, the container having an access opening with a male connector structure extending therefrom; and a fluid inlet/discharge structure comprising:
a base portion;
a gaseous fluid inlet port formed in the base portion;
a liquid discharge port formed in the base portion; and
a female access opening connector flange extending from the base portion for connection to the male connector structure of the container.

15. The liquid dispensing system defined in claim 14, wherein the system further comprises at least one gaseous fluid treatment device in a gaseous fluid inlet line which enters the gaseous fluid inlet port.

16. The liquid dispensing system defined in claim 15, wherein the at least one gaseous fluid treatment device primarily removes undesired water vapor from the gaseous fluid.

17. The liquid dispensing system defined in claim 14, wherein a gaseous fluid inlet line conveys treated gaseous fluid through the gaseous fluid inlet port into the container and a liquid discharge line conveys liquid from the container through the liquid discharge port.

18. The liquid dispensing system defined in claim 17, wherein the discharged liquid is conveyed through the liquid discharge line to a liquid applicator device.

19. A fluid inlet/discharge structure adapted to be connected to an opening of a container comprising:
a base portion having inner and outer major surfaces;
at least one reinforcing member attached to the base member;
a gaseous fluid inlet opening extending through the base portion and the at least one reinforcing member;
a liquid discharge opening extending through the base portion and the at least one reinforcing member;
a male gaseous fluid inlet structure extending from the outer major surface of the base portion and connected to the gaseous fluid inlet opening, forming a gaseous fluid inlet port;
a male liquid discharge structure extending from the inner and outer major surfaces of the base portion and connected to the liquid discharge opening, forming a liquid discharge port; and
a female access opening connecting flange extending from the base portion capable of connecting to a male access opening connector structure on a liquid material container.

20. The fluid inlet/discharge structure defined in claim 19, wherein the female connecting flange has threads formed in an inner surface thereof.

21. The fluid inlet/discharge structure defined in claim 19, wherein the female connecting flange has a snap-fit flange formed in an inner surface thereof.

22. A liquid dispensing system comprising a container capable of holding a quantity of a liquid material having an access opening to which a fluid inlet/discharge structure is operably connected in a liquid-tight manner, the fluid inlet/discharge structure having a base portion further comprising a treated gaseous fluid inlet port and a liquid discharge port.

23. A method of dispensing liquid from a container comprising:
treating a gaseous fluid to reduce moisture/remove contaminants therefrom;
conveying the treated gaseous fluid through an inlet line to a fluid inlet/discharge structure connected to a container;
injecting the treated gaseous fluid into the container through a gaseous fluid inlet port in the fluid inlet/discharge structure;
discharging liquid from the container through a liquid discharge port in the fluid inlet/discharge structure;
conveying the discharged liquid through a discharge line to a liquid application system; and
applying the liquid to an article.

24. The method of dispensing liquid defined in claim 23, wherein the liquid comprises an adhesion-promoting primer.

25. The method of dispensing liquid defined in claim 23, wherein the article is a glass vehicle window.

26. The method of dispensing liquid defined in claim 23, wherein a conveying force is provided by a pump or like device.
